(19) United States
(12) Patent Application Publication
(10) Pub. No.: US 2006/0262353 A1
(43) Pub. Date: Nov. 23, 2006

(54) Dynamic saturation adjustments via a curve control

(75) Inventors: Karthik G. Anbalagan, Bellevue, WA (US); Alexander S. Brodie, Redmond, WA (US); David R. Parlin, Redmond, WA (US); Douglas A. Ricard, Woodinville, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/133,992

(22) Filed: May 20, 2005

(51) Int. Cl. H04N 1/40

(52) U.S. Cl. 358/3.01

(57) ABSTRACT

A method and machine-readable medium for adjusting image saturation is disclosed. A designation of a change in a selected saturation distribution value of an image is received from a user. A saturation curve is automatically generated on a saturation histogram so that the saturation curve passes through the changed saturation distribution value. Saturation of the image is automatically adjusted based on the saturation curve.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to image editing. More particularly, the present invention relates to adjusting image saturation.

### BACKGROUND OF THE INVENTION

Adjusting the saturation in an image has always been limited to the use of a slider control that applies a linear shift in saturation to the image. For example, a user may increase or decrease overall saturation in an image. This results in clipping, where the most saturated parts of the image risk becoming oversaturated, and may also result in the most unsaturated parts of the image becoming undersaturated. In order to manipulate the saturation of only certain portions of an image, users would have to create complicated selections and then adjust the saturation of the selected areas individually. What is needed is a more dynamic approach to saturation adjustment that overcomes the limitations inherent in using a slider control to adjust image saturation.

### SUMMARY OF THE INVENTION

The present invention generally relates to a method and machine-readable medium for adjusting image saturation. In one embodiment, a method of adjusting image saturation is described that comprises receiving from a user a designation of a change in a selected saturation distribution value of an image, automatically generating a saturation curve on a saturation histogram so that the saturation curve passes through the changed saturation distribution value, and automatically adjusting saturation of the image based on the saturation curve. In another embodiment, a machine-readable medium is described that provides instructions, which, when executed by a machine, cause the machine to perform operations for adjusting image saturation, and comprises receiving from a user a designation of a change in a selected saturation distribution value of an image, automatically generating a saturation curve on a saturation histogram so that the saturation curve passes through the changed saturation distribution value, and automatically adjusting saturation of the image based on the saturation curve. In a further embodiment, a method of adjusting image saturation is described that comprises displaying a saturation histogram of an image, receiving from a user a designation of a change in a selected saturation distribution value of the image, automatically generating a saturation curve on the saturation histogram so that the saturation curve passes through the changed saturation distribution value, and automatically adjusting a plurality of other saturation distribution values of the image based on the saturation curve.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIGS. 2A-2G are illustrations of saturation histograms and curves for dynamically adjusting image saturation, according to embodiments of the present invention;

FIG. 3 is a flowchart illustrating dynamic saturation adjustment, according to embodiments of the present invention; and

FIG. 4 is a series of flowcharts illustrating the designation of a change in a saturation distribution value, according to embodiments of the present invention.

### DETAILED DESCRIPTION OF THE INVENTION

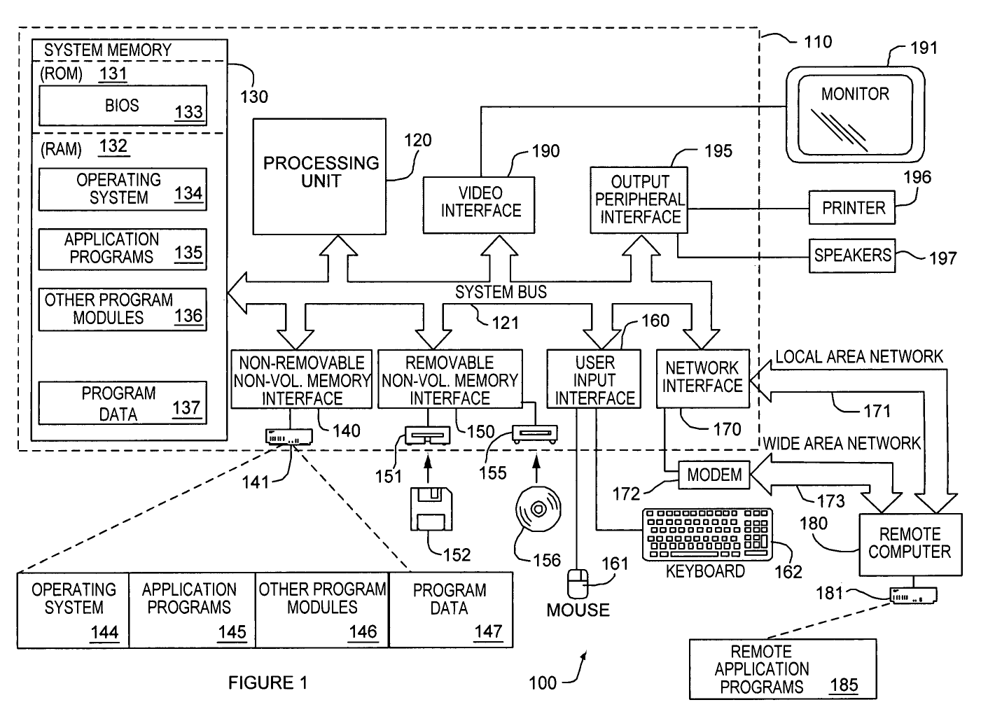

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Interconnect (PCI) bus also know as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable medial may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently begin operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drive and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different number here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user network interface 170, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

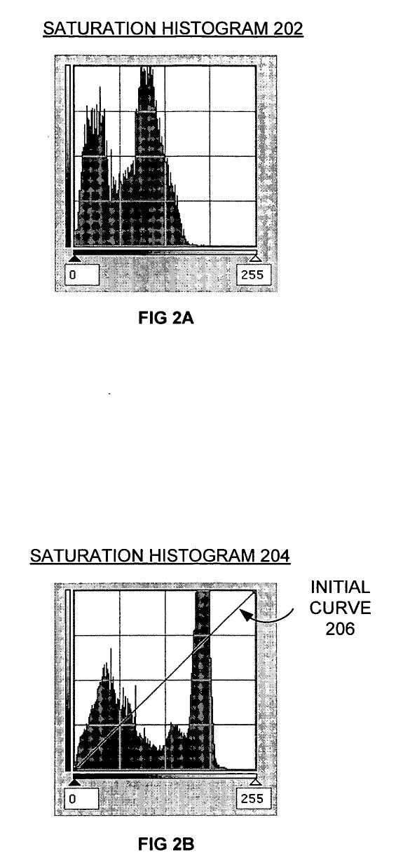

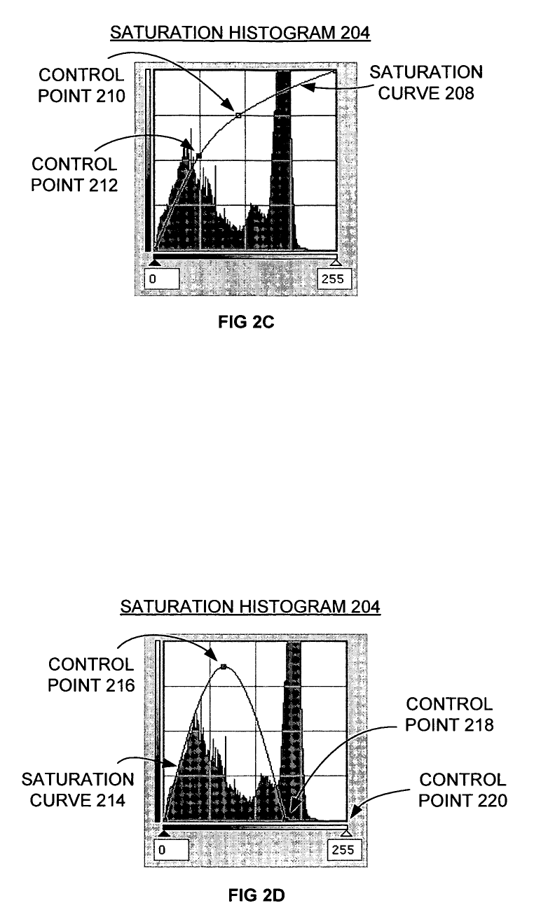

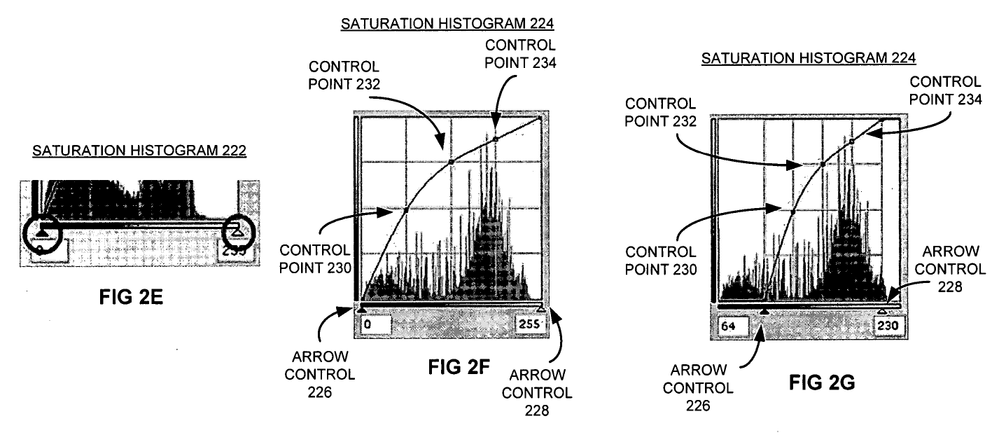

FIGS. 2A-2G are illustrations of saturation histograms and curves for dynamically adjusting image saturation, according to embodiments of the present invention. FIG. 2A illustrates saturation histogram 202, which is a saturation histogram of an image. Saturation histograms are visual representations of the distribution of saturation values for a set of pixel values (either an entire image or a selection that represents part of an image), and are well known in the art. As illustrated, saturation histogram 202 represents saturation values on the x-axis and distribution values on the y-axis. However, embodiments of the present invention are not limited to any particular axis orientation, as the axes may be oriented differently in a different embodiment. In the illustrated embodiment, the 0 to 255 range on the x-axis represents just one example of the storage mechanism of an image, e.g., 256 saturation values. The present invention is not limited to any particular size or number of saturation values, and 256 is used herein throughout merely for consistency. As illustrated, saturation and distribution values begin at zero on the lower left portion of saturation histogram 202 and increase vertically and to the right. However, as mentioned above, embodiments of the present invention are not limited to any particular orientation of the histogram. In saturation histogram 202, for each saturation value on the x-axis, a corresponding distribution value on the y-axis determines the plotted coordinate. By examining saturation histogram 202, it can be determined that the subject image is relatively undersaturated, because there is a very low distribution of saturation values in the right half of saturation histogram 202.

In an embodiment, the algorithm used to calculate saturation level is as follows; however, embodiments of the present invention are not limited to any particular algorithm, as other algorithms may be implemented as desired. Color and luminance corrections are done in YIQ space (luminance and two chroma channels). YIQ is derived linearly from RGB space. Visually, it is the RGB cube rotated on end such that the bottom is black and the top is white. There is a straight line from the bottom to the top of the “cube” called “luminosity.” This is the luminance axis. Saturation is defined to be the percentage the color point is on a vector between a point on the luminance axis and a point on one of the faces of the cube where both points have the same luminance as the color point. Beginning with a pixel's RGB value, given the color point P_{C}, a point on the luminance axis is P_{L}, which has the same luminance as P_{C}. Then a point P_{F} is calculated, which is the intersection of the ray that passes from P_{C} through P_{L} with the face of the rotated cube the ray intersects. Saturation is then calculated to be:

$$\frac{Length ( {P}_{L} {P}_{F} )}{Length ( {P}_{L} {P}_{C} )}$$

Given that a point on the luminance axis has no saturation, a point on any corner is fully saturated (pure red, pure green, pure blue), and a point on any face of the cube is fully saturated—if any channel is fully saturated, the color is saturated. When saturation needs to be scaled, the IQ values may simply be scaled by this scaling factor.

FIG. 2B illustrates saturation histogram 204, which is a saturation histogram of a different image than that of FIG. 2A. Saturation histogram 204 indicates that the subject image has high saturation values in the latter portion of the third quadrant, something for which a user may want to correct. FIG. 2B also illustrates initial curve 206 overlaying saturation histogram 204. Initial curve 206 is a graph of saturation input (x-axis) versus saturation output (y-axis) prior to any saturation adjustment, and is used as a tool to adjust saturation dynamically, as will be discussed later herein. However, embodiments of the present invention are not limited to a particular choice of axes for input and output, as either may be used. Before any saturation correction is performed on an image, saturation input equals saturation output. Thus, initial curve 206, when plotted in a two-dimensional plane, is graphed as x=y, resulting in a straight line in the illustrated embodiment.

In examining initial curve 206 on saturation histogram 204, saturation input (x-axis) equals saturation output (y-axis) across all saturation values. It should be noted that while initial curve 206 is illustrated as overlaying saturation histogram 204 and as sharing the same axes visually, they do not share the same axes practically. For example, as explained above, saturation histogram 204 illustrates saturation values on its x-axis and distribution values on its y-axis, while initial curve 206 illustrates saturation input on its x-axis and saturation output on its y-axis. The usefulness of this overlaid illustration will become apparent in FIGS. 2C and 2D.

FIG. 2C also illustrates saturation histogram 204, this time overlaid with saturation curve 208. Control points 210 and 212 are also illustrated. When a user of the present invention wishes to dynamically adjust saturation of the image, he must designate a change in at least one saturation distribution value. There are several ways envisioned in the present invention in which he can accomplish the designation. The first way is to select a control point on initial curve 206 (x-coordinate=y-coordinate) and then change the coordinates of the control point such that the x-coordinate no longer equals the y-coordinate. For example, referring back to FIG. 2B, if the user selected as a control point any point on initial curve 206, and, referring again to FIG. 2C, adjusted that control point so that it was located on the first vertical line from the left and slightly above the second horizontal line from the bottom, the resulting adjusted control point would resemble the location of control point 212. In an embodiment, multiple control points may be selected and adjusted, and if the user also selected another control point and adjusted that control point so that it was located on the third horizontal line from the bottom and just to the left of the second horizontal line from the left, the resulting adjusted control point would resemble the location of control point 210. Selection and adjustment of the control points may be accomplished using any of a number of well known user input operations, e.g., drag and drop.

The second way in which a user can designate a change in at least one saturation distribution value is simply to select a point in saturation histogram 204 that is not on initial curve 206. Thus, the user indicates control point 210 as his selection, perhaps by selecting it directly, or by selecting a nearby point and adjusting his selection onto the desired location. Again, single or multiple control points may be selected and adjusted as desired, and may be accomplished using the same well known input operations. For example, control point 212 may be selected in the same manner.

The third way in which a user can designate a change in at least one saturation distribution value is to hover a cursor over a particular point in the subject image, i.e., the hover point, and to view the corresponding point displayed as a potential selection on initial curve 206 in saturation histogram 204, i.e., the potential point. The user may hover over different points in the subject image until he determines that the hover point is the desired point, and then the user may indicated his selection of the potential point as a control point, e.g., by a mouse click. Similar to the first way of designating a change, the user may then adjust the control point off of the initial curve, resulting in, e.g., control point 210 in an embodiment. This third way is particularly desirable if the user is unfamiliar with saturation histograms and wants to see the distribution of a particular saturation level by hovering over a point in the subject picture, e.g., a bright blue sky. By hovering and viewing the potential point on saturation histogram 204, the user is able to better control the saturation adjustment that he is about to make. As with the other ways of designating a change, multiple control points may be selected, e.g., control point 212 may be selected in the same manner.

Note that while some control points may in fact end up on initial curve 206, at least one control point must be adjusted to a location off of initial curve 206, or else the saturation distribution will remain unchanged. In addition, as would be apparent to someone of ordinary skill in the art, one or multiple control points may be selected, and only two are shown and described in FIG. 2C for simplicity. Also, embodiments of the present invention are not limited to any particular adjusted control point coordinates, as control points 210 and 212 may end up anywhere in saturation histogram 204. This enables the user to adjust any saturation distribution value in any way he chooses, i.e., increase or decrease by any magnitude. Often, only minor adjustments are necessary, however in some instances major adjustments are desirable. Also, control points may be selected and adjusted independently of one another, representing a major advantage over the previous implementations of linear saturation adjustment. For example, the user may reduce one saturation distribution value and increase another, all without any complex selections. An infinite number of permutations of control points and their locations are possible, giving the user unprecedented control over the saturation of the subject image in an uncomplicated manner.

Referring to FIG. 2C, once at least one control point (adjusted to a location off of initial curve 206) has been selected indicating a designated change in at least one saturation distribution value, saturation curve 208 is generated. Saturation curve 208 is similar to initial curve 206 in that it indicates saturation input and saturation output on the x-axis and y-axis, respectively. As with initial curve 206, saturation curve 208 may take any orientation depending on the orientation and assignment of the axes. Saturation curve 208 is generated according to a saturation function. In an embodiment, the saturation function is a cubic spline function; however, embodiments of the present invention are not limited to any particular function, as other well known functions may be implemented as desired. As would be understood by someone of ordinary skill in the art, the math to calculate a cubic spline is as follows. Given a set of points (x0, y0), (x1, y1), . . . , (xn, yn) a (natural) cubic spline S(x) for those points satisfies:
On each interval [xj, xj+1], S(x)=Sj(x) is a cubic polynomial (the whole spline is composed of several functions of the form f(x)=a+bx+cx2+dx3, one each between each pair of adjacent points)
S(xj)=yj for each j=0, 1, . . . , n (the spline runs through all the points, which also means that where adjacent polynomials meet they have the same coordinate)
S′j+1(xj+1)=S′j(xj+1) for each j=0, 1, . . . , n−2 (the points where adjacent polynomials meet share the same first order derivative)
S″j+1(xj+1)=S″j(xj+1) for each j=0, 1, . . . , n−2 (the points where adjacent polynomials meet share the same second order derivative)
(natural condition:) S″(x0)=S″(xn)=0

For purposes of the present invention, the points (x0, y0), (x1, y1), . . . , (xn, yn) are provided by the user in the form of control points. A standard algorithm is used to generate the coefficients for the polynomials in (a) to define the spline. Once the coefficients are known, the function can be determined and plotted. Once plotted, the saturation distribution levels of the subject image may be adjusted according to saturation curve 208. For example, the creation and adjustment of control points 210 and 212 results in the adjustment of saturation output values of other points along initial curve 206 as well. Originally, initial curve 206 passed through the third vertical line from the left at the third horizontal line from the bottom in saturation histogram 204. After adjustment according to the control points, saturation curve 208 crosses the third vertical line at a point above the third horizontal line, indicating a resulting increase in distribution at the saturation level indicated by the third vertical line. However, the user did not have to manually adjust the saturation distribution of the saturation level indicated by the third vertical line. Such adjustment was done automatically according to saturation curve 208. In FIG. 2C, the result of the saturation adjustment indicated by saturation curve 208 is more of an increase in the lower saturation values and less of an increase in the higher saturation values. This may be more desirable to the user, because already highly saturated portions of the subject image won't be oversaturated as a result of raising the saturation of relatively low saturated portions of the subject image. However, embodiments of the present invention are not limited to any particular saturation curve design, as it is totally dependent upon the adjustment of the control point(s) by the user.

By utilizing the saturation curve, the saturation adjustment is no longer linear. While curves have been used for other image adjustments, e.g., brightness, they have never been used to adjust saturation. Such a new use of dynamic curves for saturation adjustment is nonobvious because it is a highly effective way to adjust saturation, but it has never been implemented or suggested prior to the present invention.

FIG. 2D illustrates saturation histogram 204 again, this time with differently adjusted control points resulting in a different saturation curve. Control points 216, 218, and 220 have been selected/adjusted differently than control points 210 and 212, resulting in a dramatically different saturation curve 214. As illustrated, the higher saturation values have been adjusted to zero, and the low-to-middle saturation values have been adjusted higher. While this would likely result in a strange appearance of the subject image, it demonstrates that any results desired by the user are possible and easy to achieve compared to the former linear slider method of saturation adjustment.

FIG. 2E illustrates a lower portion of saturation histogram 222. Left and right arrow controls are circled in FIG. 2E. In an embodiment of the present invention, saturation may also be adjusted using the arrow controls. FIG. 2F illustrates saturation histogram 224. Saturation histogram 224 contains arrow control 226 and arrow control 228. As illustrated, control points 230, 232, and 234 have already been selected by a user, resulting in the illustrated saturation curve. However, embodiments of the present invention are not limited to any particular number or location of control points. FIG. 2G illustrates saturation histogram 224 again, but with a saturation curve and control points that have been adjusted by relocating arrow control 226 and arrow control 228. In an embodiment, the user may adjust all of the control points (in the case of FIG. 2G, control points 230, 232, and 234) by adjusting one or both arrow controls 226 and 228.

While not required, the text boxes below the initial locations of arrow controls 226 and 228 are linked to the values of arrow controls 226 and 228 such that changing either the text value or the location of the arrow control will force the other to change to that value. For example, a user may adjust arrow control 228 as illustrated, and the text box corresponding to arrow control 228 will automatically change to read “230.” Also, the user may adjust the text box corresponding to arrow control 228 (originally reading “255”) to read “230,” and arrow control 228 will be adjusted to the location illustrated in FIG. 2G. The user may choose any value for the text boxes or the arrow controls. Upon adjusting the arrow controls (either directly or by the text boxes), the control points are automatically adjusted as well to fit within the range. In the example illustrated in FIG. 2F, control point 230 had an x-coordinate at 25%, control point 232 had an x-coordinate at 50%, and control point had an x-coordinate at 75%. When arrow control 226 is adjusted from “0” to “64” (approximately 25%) and arrow control 228 is adjusted from “255” to “230” (approximately 90%) as illustrated in the example in FIG. 2G, control point 230 is automatically adjusted to have an x-coordinate of approximately 41%, control point 232 is automatically adjusted to have an x-coordinate of approximately 58%, and control point 234 is automatically adjusted to have an x-coordinate of approximately 74%. In addition, the saturation curve is re-drawn to include the adjusted control points and saturation of the image is adjusted accordingly. Embodiments of the present invention are not limited to any particular beginning or adjusted values for the arrow controls or control points.

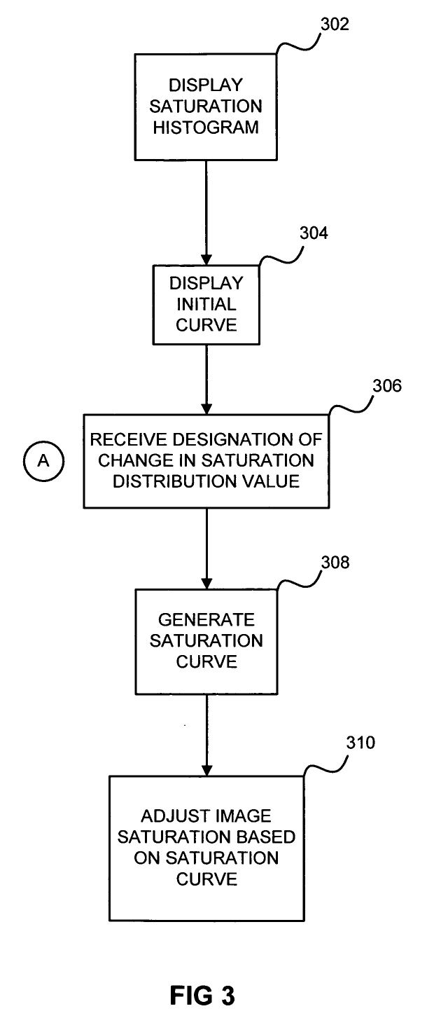

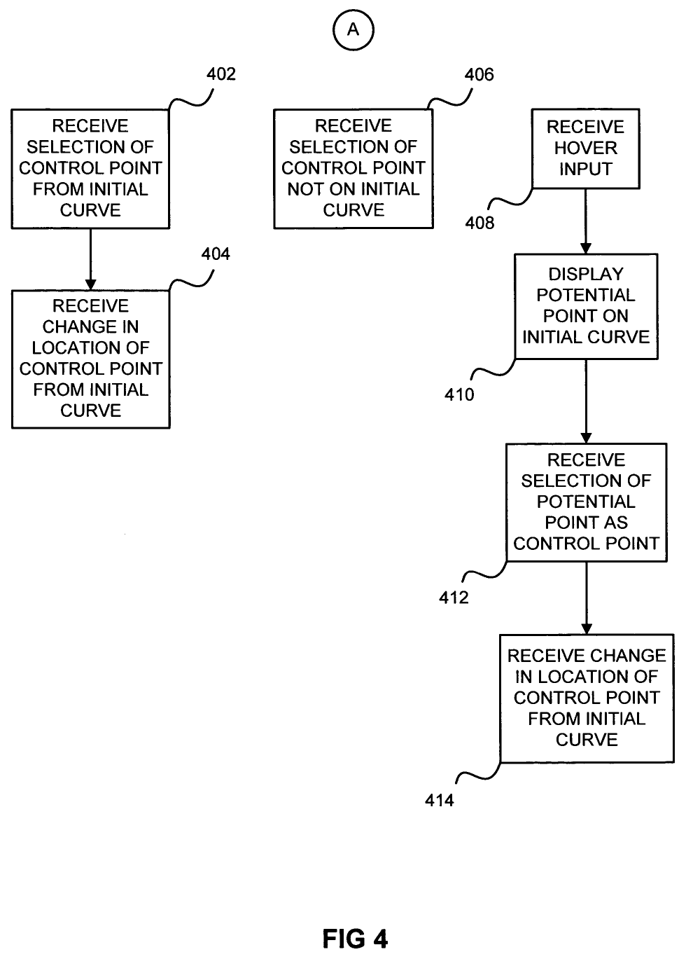

FIG. 3 is a flowchart illustrating dynamic saturation adjustment, according to embodiments of the present invention. In an embodiment, the operations illustrated in FIG. 3 may be performed by a user interface application; however, embodiments of the present invention are not limited to any particular application. As illustrated in FIG. 3, a saturation histogram is displayed to a user (302). An initial curve is displayed to the user (304). As discussed above, the initial curve overlays the saturation histogram. A designation of a change in a saturation distribution value is received from the user (306). As noted in FIG. 3, a cross-reference to FIG. 4, as indicated by the circled “A,” explains this change designation in greater detail. A saturation curve is generated (308). As discussed above, the saturation curve may be generated using any of a number of saturation functions, e.g., a cubic spline function. Image saturation is adjusted based on the saturation curve (310). As discussed above, saturation distribution values are increased or decreased as a result of the application of the saturation curve.

FIG. 4 is a series of flowcharts illustrating the designation of a change in a saturation distribution value, according to embodiments of the present invention. Specifically, FIG. 4 illustrates the three alternative ways in which a change in a saturation distribution value may be designated, which were discussed above. In the left column of FIG. 4, the first way discussed above is illustrated. In particular, a selection of a control point from the initial curve is received from a user (402). A change in location of the control point to a location off of the initial curve is then received from a user (404). In the middle column of FIG. 4, the second way discussed above is illustrated. Specifically, a selection of a control point that is not located on the initial curve is received (406). In the right column of FIG. 4, the third way discussed above is illustrated. Namely, a hover input is received from a user (408). A potential point on the initial curve is displayed (410). A selection of the potential point as the control point is received from the user (412). A change in location of the control point to a location off of the initial curve is then received from the user (414).

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The invention claimed is:

1. A method of adjusting image saturation, comprising:
receiving from a user a designation of a change in a selected saturation distribution value of an image;
automatically generating a saturation curve on a saturation histogram so that the saturation curve passes through the changed saturation distribution value; and
automatically adjusting saturation of the image based on the saturation curve.

2. The method of claim 1, further comprising:
displaying an initial curve on the saturation histogram, wherein the initial curve illustrates a saturation input on a first axis and a saturation output on a second axis, and wherein the saturation input is equal to the saturation output.

3. The method of claim 2, further comprising:
receiving from the user a selection input to select a control point from the initial curve,
wherein the change designation is a change in the location of the control point such that the control point is no longer on the initial curve.

4. The method of claim 2, wherein the change designation is a selection of a control point on the saturation histogram that is not on the initial curve.

5. The method of claim 2, further comprising:
receiving from the user a hover input to hover a cursor over a hover point in the image;
automatically displaying a potential point on the initial curve corresponding to the hover point;
receiving from the user a selection input to select the potential point as a control point,
wherein the change designation is a change in the location of the control point such that the control point is no longer on the initial curve.

6. A machine-readable medium that provides instructions, which, when executed by a machine, cause the machine to perform operations for adjusting image saturation, comprising:
receiving from a user a designation of a change in a selected saturation distribution value of an image;
automatically generating a saturation curve on a saturation histogram so that the saturation curve passes through the changed saturation distribution value; and
automatically adjusting saturation of the image based on the saturation curve.

7. The machine-readable medium of claim 6, wherein the instructions cause the machine to perform operations further comprising:
displaying an initial curve on the saturation histogram, wherein the initial curve illustrates a saturation input on a first axis and a saturation output on a second axis, and wherein the saturation input is equal to the saturation output.

8. The machine-readable medium of claim 7, wherein the instructions cause the machine to perform operations further comprising:
receiving from the user a selection input to select a control point from the initial curve,
wherein the change designation is a change in the location of the control point such that the control point is no longer on the initial curve.

9. The machine-readable medium of claim 7, wherein the change designation is a selection of a control point on the saturation histogram that is not on the initial curve.

10. The machine-readable medium of claim 7, wherein the instructions cause the machine to perform operations further comprising:
receiving from the user a hover input to hover a cursor over a hover point in the image;
automatically displaying a potential point on the initial curve corresponding to the hover point;
receiving from the user a selection input to select the potential point as a control point,
wherein the change designation is a change in the location of the control point such that the control point is no longer on the initial curve.

11. A method of adjusting image saturation, comprising:
displaying a saturation histogram of an image;
receiving from a user a designation of a change in a selected saturation distribution value of the image;
automatically generating a saturation curve on the saturation histogram so that the saturation curve passes through the changed saturation distribution value; and
automatically adjusting a plurality of other saturation distribution values of the image based on the saturation curve.

12. The method of claim 11, wherein the saturation curve is generated according to a saturation function.

13. The method of claim 12, wherein the saturation function is a cubic spline.

14. The method of claim 11, further comprising:
displaying an initial curve on the saturation histogram, wherein the initial curve illustrates a saturation input on a first axis and a saturation output on a second axis, and wherein the saturation input is equal to the saturation output.

15. The method of claim 14, further comprising:
receiving from the user a selection input to select a control point from the initial curve.

16. The method of claim 15, wherein the change designation is a change in the location of the control point such that the control point is no longer on the initial curve.

17. The method of claim 14, wherein the change designation is a selection of a control point on the saturation histogram that is not on the initial curve.

18. The method of claim 14, further comprising:
receiving from the user a hover input to hover a cursor over a hover point in the image; and
automatically displaying a potential point on the initial curve corresponding to the hover point.

19. The method of claim 18, further comprising:
receiving from the user a selection input to select the potential point as a control point.

20. The method of claim 19, wherein the change designation is a change in the location of the control point such that the control point is no longer on the initial curve.
